(19) United States
(12) Patent Application Publication
(10) Pub. No.: US 2022/0394463 A1
(43) Pub. Date: Dec. 8, 2022

(54) COMMUNICATION DEVICE AND METHOD FOR SECURE COMMUNICATION

(71) Applicant: Sony Group Corporation, Tokyo (JP)

(72) Inventors: Felix FELLHAUER, Stuttgart (DE); Maximilian ARNOLD, Stuttgart (DE); Stephen TIEDEMANN, Stuttgart (DE); Dana CIOCHINA, Stuttgart (DE); Thomas HANDTE, Stuttgart (DE); Nabil Sven LOGHIN, Stuttgart (DE)

(73) Assignee: Sony Group Corporation, Tokyo (JP)

(21) Appl. No.: 17/774,149

(22) PCT Filed: Nov. 9, 2020
(86) PCT No.: PCT/EP2020/081492

§ 371 Date: May 4, 2022

(30) Foreign Application Priority Data
Nov. 14, 2019 (EP) 19209181.7

(51) Int. Cl. H04W 12/02; H04W 12/122; H04K 3/00

(52) U.S. Cl. CPC H04W 12/02; H04W 12/122; H04K 3/825; H04K 2203/18

(57) ABSTRACT

A first communication device for use in a wireless communication system to communicate with a second communication device comprises circuitry configured to transmit probe signals into multiple directions, receive echo signals in response to the transmitted probe signals, and determine the position of a potentially eavesdropping communication device from the received echo signals.

### BACKGROUND

### Field of the Disclosure

The present disclosure relates to a first communication device and method for use in a wireless communication system to communicate with a second communication device in a secure manner.

### Description of Related Art

Secure messaging between an information sender and an intended recipient is one of the fundamental challenges in communication systems. In order to not let information pass to an unintended recipient (an adversary or eavesdropper), care must be taken to control the environment and/or cryptographically secure the information so that only the intended recipient is able to understand the information transmitted. Cryptographic approaches usually operate on upper layers of the transmission protocol. Once the signal is intercepted on a lower layer, such as PHY layer (over the medium, such as RF waves), brute force decryption may be possible, especially when the packet lengths and encryption keys are relatively short. This is especially true for Internet of Things (IOT) applications, in which typically only a few bits or bytes may be transmitted. Thus, PHY layer security has been considered as an additional means to protect the signal already on PHY layer.

In a wireless communication system, all participants (hereinafter also called communication devices) share the same communication medium and are able to listen (or eavesdrop) on any communication within receive range. According to conventional approaches, information that shall not be shared with all potential recipients might be encrypted using keys exclusively known to the sender and receiver. One way to establish those keys is to derive them from a pre-shared secret (also known as the network password) given to legitimate participants for association with the network. Unless further measures are taken, all participants are then able to decrypt information from any other participant that is part of the network. To mitigate the problem of potential “eavesdropping” of sensitive information, concepts for Point-to-Point encryption for such networks exist. Nevertheless, an exchange of an encryption key is required to establish a secure communication link. A common solution is implemented in the Extensible Authentication Protocol (EAP), which is used in the context of IEEE 802.11 wireless LANs to exchange keys. The handshake procedure that takes place in the set-up phase of such a secure connection is still sensitive, and if it is eavesdropped, all subsequent communication can be decrypted and captured by a potential eavesdropper.

The “background” description provided herein is for the purpose of generally presenting the context of the disclosure. Work of the presently named inventor(s), to the extent it is described in this background section, as well as aspects of the description which may not otherwise qualify as prior art at the time of filing, are neither expressly nor impliedly admitted as prior art against the present disclosure.

### SUMMARY

It is an object to provide a communication device that can detect the presence of a potential eavesdropper. It is a further object of an embodiment to use this information to prevent or at least make it more difficult that a potential eavesdropper can actually eavesdrop on the communication between a first communication device and a second communication device. It is a further object to provide corresponding communication method as well as a corresponding computer program and a non-transitory computer-readable recording medium for implementing said communication method.

According to an aspect there is provided a first communication device for use in a wireless communication system to communicate with a second communication device, the first communication device comprising circuitry configured to
transmit probe signals into multiple directions,
receive echo signals in response to the transmitted probe signals, and
determine the position of a potentially eavesdropping communication device from the received echo signals.

According to a further aspect there is provided a first communication method of a first communication device for use in a wireless communication system to communicate with a second communication device, the first communication method comprising
transmitting probe signals into multiple directions,
receiving echo signals in response to the transmitted probe signals,
determining the position of a potentially eavesdropping communication device from the received echo signals.

According to still further aspects a computer program comprising program means for causing a computer to carry out the steps of the method disclosed herein, when said computer program is carried out on a computer, as well as a non-transitory computer-readable recording medium that stores therein a computer program product, which, when executed by a processor, causes the method disclosed herein to be performed are provided.

Embodiments are defined in the dependent claims. It shall be understood that the disclosed communication method, the disclosed computer program and the disclosed computer-readable recording medium have similar and/or identical further embodiments as the claimed communication device and as defined in the dependent claims and/or disclosed herein.

In contrast to wired networks, where all network participants are (quasi-) statically connected to the medium, wireless communication systems broadcast their message to everyone in a certain proximity, depending on the propagation characteristics of the underlying radio frequencies. To mitigate this, wireless communication networks provide the option to exploit spatial properties like directivity, especially for higher frequencies. Additionally, the wireless medium and its properties are dependent on multiple parameters like position and orientation of devices, time, etc. According to embodiments of the present disclosure, one or more of these properties are used in order to increase security of the exchange of information between a first and a second communication device and thus to decrease the probability of eavesdropping by a third communication device (i.e., a potential eavesdropper) in a wireless communication system (such as a wireless LAN network), especially in the 60 GHz (or mmWave) frequency spectrum, or in a similar spectrum such as e.g., 28 GHz, which is used for 5G cellular communication.

For this purpose, the positions of potential eavesdroppers are determined by evaluating the echoes received in response to the transmission of probe signals. Additionally, in some embodiments a corresponding evaluation by the second communication device (the communication partner) may take place. This is not strictly required, as the communication partner usually collaborates with the first communication device during a beam training phase, and thus the direction of a second communication device relative to the first communication device is already known. Based on the position information of potential eavesdroppers, the transmission of the desired message may in one embodiment be controlled with the aim that the second communication device but not the potential eavesdropper can receive it. In one embodiment, additionally or alternatively, artificial noise (also called jamming signals) may be transmitted to locally jam the potential eavesdropper, i.e. the transmission of the artificial noise may be controlled such that the potential eavesdropper receives the message and artificial noise and thus cannot decode the message, while the second communication device still can successfully receive and decode the message. In this way the probability that a third communication device (the potential eavesdropper) can eavesdrop on the communication between the first communication device and the second communication device is much reduced or even minimized.

It shall be noted that determining the position of a device shall be understood in the context of the present disclosure such that at least the direction in which the device (e.g. the second communication device or the potential eavesdropper) is arranged with respect to another device (e.g. the first communication device) is determined. It is not required that the (exact) two- or three-dimensional (absolute or relative) position of the device is determined.

The foregoing paragraphs have been provided by way of general introduction, and are not intended to limit the scope of the following claims. The described embodiments, together with further advantages, will be best understood by reference to the following detailed description taken in conjunction with the accompanying drawings.

### BRIEF DESCRIPTION OF THE DRAWING

A more complete appreciation of the disclosure and many of the attendant advantages thereof will be readily obtained as the same becomes better understood by reference to the following detailed description when considered in connection with the accompanying drawings, wherein:

FIG. 1 shows a diagram illustrating the secrecy rate as function of the receiver's SNR and a wire-tapper's SNR.

FIG. 2 shows a diagram illustrating the coded modulation secrecy rate for 4-QAM over receiver SNR and different receiver SNR values at the wire-tapper.

FIG. 3 shows a diagram illustrating the coded modulation secrecy rate for a coupled system with different attenuation factor and different modulation schemes.

FIG. 4 shows diagrams illustrating an embodiment for increasing security of messaging according to the present disclosure.

FIG. 5 shows a schematic diagram of a communication system according to the present disclosure.

FIG. 6 shows a schematic diagram of the configuration of a first and second communication device according to an embodiment of the present disclosure.

FIG. 7 shows a schematic diagram of a communication method according to an embodiment of the present disclosure.

### DETAILED DESCRIPTION OF THE EMBODIMENTS

In conventional communication systems, usually a single link between a transmitter and a receiver and its properties is the objective of engineering. The typical metric to characterize the upper bound of communication throughput of these systems is the Shannon capacity, measured in bit per second per Hertz or bit per channel use (bpcu). The Shannon capacity (in the following assuming an additive white Gaussian noise channel model (AWGN)) can be determined based on the received signal to noise ratio (SNR) according to:

$$C = {log}_{2} ( 1 + \frac{S}{N} )$$

with signal power S, and noise power N. The signal to noise ratio (S/N) is usually (in linear systems) proportional to the transmit power P_{TX}. Usually, a communication system is designed in a way that C is maximized, assuming a single information source A and a single information sink B are involved.

Assuming that another information sink E exists (also called “wire-tapper” or “Eve” for eavesdropper) that can eavesdrop the signals transmitted by A, this can be considered as a secrecy system. In order to quantify the secrecy of the system, a commonly known metric is the so called secrecy rate (SR) C^{S} that is defined as the difference between achievable rate of “A to B” and achievable rate of “A to E”:

C^{S}=C(SNR_{A})−C(SNR_{E})

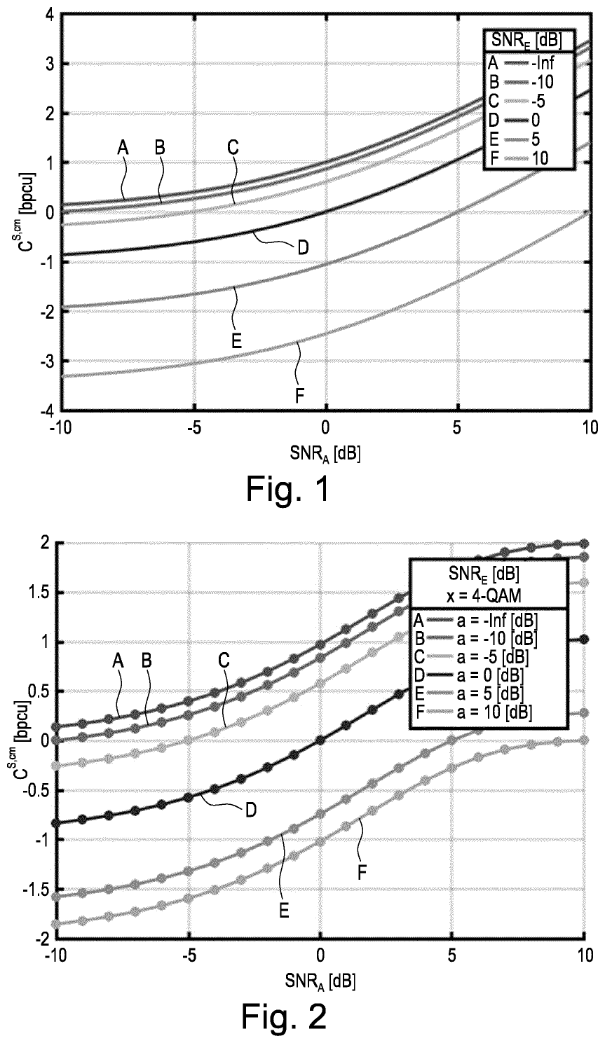

A simple visualization of this relation is shown in FIG. 1. It is obvious that the best secrecy rate can be achieved if SNR_{A}>>SNR_{E}. It is obvious that C^{S} can even become negative in situations where SNR_{E}>SNR_{A}, which is also the case in parts of FIG. 1.

In practical communication systems, the full Shannon capacity can never be reached (limited A/D resolution, finite complexity, . . . ). Therefore the secrecy rate shown in FIG. 1 can be seen as an upper bound. A more realistic metric is the coded modulation (CM) capacity that assumes an AWGN channel, discrete-valued input, a continuous-valued output and a modulation scheme that is used to map binary information to symbols. For a uniform input distribution and the signal constellation alphabet χ with m bit per symbol (Mary constellation with M=2^{m}), the CM capacity between channel input X and output Y can be expressed by:

$${C}_{χ}^{cm} = E [ {log}_{2} \frac{P ( Y \vert X )}{\frac{1}{{2}^{m}} {\sum }_{{x}^{′} ∈ χ} P ( Y \vert {x}^{′} )} ] ,$$

with E[.] being the expectation operator and P(.) being a conditional probability. Based on the CM capacity, a more realistic CM secrecy rate can be defined that is visualized for a 4-QAM constellation in FIG. 2, i.e. a more realistic metric of achievable data rate for a single link. As shown below, the difference of two links can give a metric for secrecy:

C^{S,cm}=C^{cm}(SNR_{A})−C^{cm}(SNR_{E})

Another metric that can be used to define the secrecy rate is the bit interleaved coded modulation (BICM) capacity, taking into account additional practical limitations of communication systems. Still, it is obvious that the highest CM secrecy rate can be achieved when SNR_{A} is high and SNR_{E} is low. But in contrast to the secrecy rate shown in FIG. 1, it can be seen that the CM secrecy rate behaves asymptotically with respect to both SNR parameters, thus limiting the curves to [−m, +m].

In a typical scenario, the SNR of A and E are not independent, but both proportional to the transmit power that is used by A. Thus, a coupled CM secrecy rate can be defined by introducing an attenuation factor a defining the SNR-offset between A and E:

SNR_{A}|_{dB}=P_{TX}|_{dBm}−P_{L}|_{dB}−P_{N,A}|_{dBm}

SNR_{E}|_{dB}=SNR_{A}|_{dB}+a|_{dB}

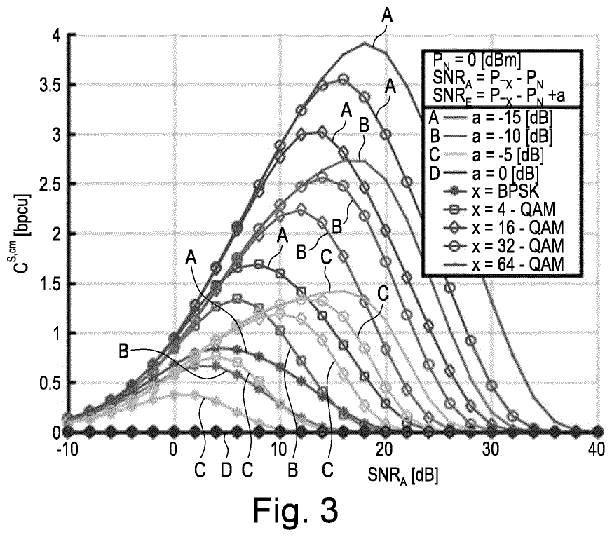

with transmit power P_{TX}, path loss P_{L} noise power at A/E P_{N,A/E} and attenuation factor a. It shall be noted that P_{RX}|_{dBm}=P_{TX}|_{dBm}−P_{L}|_{dB} defines the received signal power taking into account the path loss P_{L}|_{dB}, which can be treated as a constant offset and is thus not further considered in the context of this disclosure. Thus, it is defined: P_{L}|_{dB}=0 dB. Using this definition, it can be shown that there exists an optimum P_{TX} for each combination of a and x that maximizes C^{S}, cm. This relation is visualized for an explanatory set of x and a in FIG. 3.

Thus, for a secure communication system, an optimization goal can be defined in order to provide the highest possible CM secrecy rate:

max{C^{S,cm}(P_{TX},χ,a)}

Additionally, it might be considered to maximize the above mentioned metric under the additional constraint of a specific minimal communication rate/capacity C_{target}, resulting in the following constrained optimization problem:

max{C^{S,cm}(P_{TX},χ,a)} with C^{cm}(P_{TX},χ,a)≥C_{target}

Another formulation might target minimization of the eavesdropper's rate/capacity:

min{C^{cm,E}(P_{TX},χ,a)} with C^{cm,A}(P_{TX},χ,a)≥C_{target}

Besides the above-mentioned theoretic aspects on security, in implementations of communication systems, data is usually protected by Forward Error Correcting Codes (FECs) in order to make the transmission more robust against effects of noise or interference. These codes are usually designed in order to minimize the probability of bit errors in the received message (bit error rate (BER)) for a given SNR or SNR range (or channel conditions in general). Designing these codes with respect to maximizing the above-mentioned metrics is another approach to enhance physical layer security.

In order to reach this goal an approach will be described in the following that aims to influence the three parameters P_{Tx}, χ and a specifically for mmWave communication systems.

The above-introduced metric for secrecy provides one possible perspective on the problem of providing secrecy in a communication system. Other possible metrics include:
Bit Error Rate (BER): BER observed by a potential eavesdropper shall be maximized (i.e. should be close to ½, which implies that half of the received bits are faulty)
Packet Error Rate (PER): PER observed by a potential eavesdropper shall be as high as possible (i.e. close to 1, which implies that none of the received packets can be decoded successfully).
Signal-to-Noise-Ratio difference (μ): SNR of a signal sent by A, observed at the dedicated receiver B shall be as high as possible, compared to the SNR observed at the potential eavesdropper E. μ=SNR_{AB}|_{dB}−SNR_{AE}|_{dB}
The amount of information that is transmitted from A to B shall be maximized or reach at least a certain threshold, while the confusion of B shall be maximized.

Based on the used secrecy metric, multiple methods are generally available by which a station (STA) and access point (AP) can utilize spatial diversity to prevent other stations, like stations within the same network sharing the same cryptographic secret, to eavesdrop on communication between the station and the access point. The same method may also be used for direct communication between two stations or in other communications systems, besides WLAN.

High frequency wireless communication such as 60 GHz WLAN use directional wave radiation (beams) between the transmitter (TX) and receiver (RX) to cover even medium distances because omnidirectional radiation patterns, as used for lower frequencies, are subject to strong attenuation. Hence, two communication partners, such as a STA and AP, use beamforming antenna configurations that are learned initially and continuously updated to changing conditions such as displacement or blockage. Intuitively, the best communication path between both parties would be the transmit and receive beams directed on a straight line towards each other (line of sight, LoS). However, in typical situations there will be reflections that form indirect paths between the sender and receiver, and it may as well be that the direct path is not the best performing path due to obstacles/materials to be penetrated. But in any case, if communication is at all possible, there may be an ensemble of beam configurations (or sub-streams) that, if some or all of them are used together, provides the potential of a spatially diverse communication method. It can be shown that, if using a sufficient number of reflective path components, there is little to zero potential for an eavesdropper device to be in a position where it is able to receive the same complete superposition of sub-streams as the legitimate receiver, simply because it cannot be in the same position where all sub-streams are decodable into the full information set.

The following embodiments of the present disclosure might be applied either separately or in combination in order to enhance the secrecy of a communication system. As overall goal can be formulated that the embodiments are directed to detecting the presence and position of a potential eavesdropper. This information may then optionally be used to reduce (or even minimize) eavesdropping probability, and preferably optimizing (or even maximizing) the secrecy rate SR.

For instance, secrecy rate may be considered as a metric, in which case the security criterion shall be maximized (which may be formulated as max of {Secrecy Rate/CM SR/BICM SR} or min of {bit error rate at eavesdropper}) such that the probability of eavesdropping by a third device is minimized. Other forms of security metric/criteria can be used, such as minimization of bit error rate (BER) at the eavesdropper.

As shown in FIG. 3, essentially three parameters P Tₓ, χ and a can be used in order to influence the CM SR of a communication system. In the context of a mmWave communication system that uses phased array antennas (PAAs) to focus transmit signal power and receive sensitivity in space (so called beams), the beams to be used are selected during a beam forming procedure. Based on the selected beam and the scenario (room and position of devices), the attenuation factor a can be considered to be given as an outcome of the procedure.

In mmWave communications, usually both communication devices are equipped with PAAs, resonating at the corresponding frequency band. An electromagnetic wave impinging on a surface of an antenna interacts with the antenna structure based on two scattering phenomena: The first scattering is the so-called structural mode scattering which appears due to the metal conductor of the antenna. The remaining part of the power is actually fed into the antenna connector, where an impedance mismatch is reflecting a part of the energy back into the radiating part of the antenna, where the signal is then radiated again. This phenomenon is called antenna mode scattering.

In radio detection and ranging (RADAR) applications, a radar antenna transmits a signal into different directions and receives echoes of this signal reflected by a “target”. The amount of signal power P_{RX} that is reflected is usually modeled by means of the so-called radar cross-section (RCS) σ. The amount of received signal power can thus be modeled by:

$${P}_{R X} ( {φ}_{1} , {φ}_{2} ) = \frac{{P}_{T X} {G}_{T X} ( {φ}_{1} )}{4 π {r}^{2}} σ \frac{1}{4 π {r}^{2}} {G}_{R X} ( {φ}_{2} ) + {P}_{n} , \qquad ( 1 )$$

with
power of the transmitted signal P_{TX},
G_{TX} gain of the transmit antenna into the targets direction (in case of a steerable antenna this might be dependent on the antennas steering direction (or selected antenna beam) φ₁
distance to the target r,
gain of the receive antenna into the echo's direction G_{RX}(φ₂),
power of the received noise Pₙ.

The higher σ is, and the lower the distance to the reflecting device, the higher is the power of the echo signal that can be detected at the receiver antenna.

In the context of antennas, the amount of electric field reflected from a receiving antenna structure (scattered or re-radiated) can be separated into two distinct parts:

i) Antenna mode scattering, which depends from the antenna gain G, the matched or unmatched load Z_{L} that is attached to the antenna network, as well as other antenna parameters like polarization or angle of arrival.
ii) Residual mode scattering (or structural component of the RCS), which describes any other contributions that cannot be assigned to the first category in order to give a full description of the total radar cross-section of an antenna structure. Those components in general can depend on all parameters like the antennas structure, used materials, etc. but by definition it does not depend on the load impedance Z_{L} that is attached to the output port of the antenna.

Antenna mode scattering and residual mode scattering can cause an increase of the radar cross-section of a 60 GHz capable WLAN device that is able to “listen” into the direction of the transmitter dynamically. These effects can be combined and modeled with the radio cross-section of the antenna.

Further, the RCS of any “target” depends on the frequency of the signals used by the sender to generate the echoes. The actual frequency dependency as well as the estimated value of the RCS may be used to classify targets into categories like antenna device/potential eavesdropper or passive scatterer/obstacle. This can be done by matching the frequency dependent echo signal (spectrum) of a detected target to a set of known spectra (e.g. by means of correlation or other distance or similarity metrics).

Further, one or more these properties may be used by a first communication device in order to distinguish between different devices. In particular, a communication device may use the estimated RCS and its frequency dependent characteristic as some sort of signature and thus may be able to detect if a potential eavesdropper pretends to be a legitimate recipient.

In a preferred embodiment for WLAN in the 60 GHz band, analog beams, which are tested during analog beam training, can be used as probe signals. This is part of a sector level sweep (SLS) phase, or subsequent beam refinement. Such directed beams may be used subsequently as probe signals to detect the presence of a potential eavesdropper E. It is not required to cover a 360° around the transmitter, to detect a potential eavesdropper, because subsequent communication between transmitter and intended receiver (A and B) will only take place over one of the previously tested beams (i.e. an eavesdropper may be located on a blind spot, being undetected, but no signals are transmitted towards this spot/area).

It may be assumed that transmitter A knows the position of intended receiver B. This can be accomplished, e.g., as a byproduct of SLS and beam refinement phase, in which A and B both participate. Angle of departure (AoA) from A towards B is known at A (either hardwired or estimated from the phase settings at the phased antenna array (PAA)) for each tested beam direction (probe signal). Other known positioning techniques such as state-of-are fine time measurement (to estimate and signal time of flight information from A to B as well as Angle of Arrival (AoA) at receiver B) can further improve positioning of B. At least the direction in which B is located (without knowing the distance) is sufficient for most of the countermeasures, after detecting a potential eavesdropper.

After establishing a communication link between A and B with known position of B (or at least the direction of B), probe signals originating from A will scan for the location of a potential eavesdropper. Once a reflection of a probe signal arrives back at A, A may mark this direction as a potential eavesdropper direction. It may have also been the reflection from an object or a non-malicious device (having no intention of eavesdropping), but for security reasons, the origin of this reflection may be marked as a potential eavesdropper direction nevertheless. As a next step, A may not transmit signals in this direction, but rather initiate countermeasures to disturb potential eavesdropping (even though E is not in the area into which A is transmitting, it may still capture some energy from the electromagnetic wave; PAAs can focus the transmit energy into one direction, but leakage is always possible, e.g., via side lobes of the beams).

One countermeasure for A is to transmit jamming signals or artificial noise towards the direction of the potential eavesdropper. This can be pseudo-noise (e.g. following a Gaussian distribution for maximum entropy, i.e., maximum uncertainty) or another kind of jamming signal. This can be done simultaneously, while transmitting the intended signals towards B, when multiple PAAs are deployed at the transmitter A (Hybrid MIMO architecture). If B and E are located on the same line originating from A (i.e., B and E are located on the same direction), then secure communication may not be guaranteed. If, however, the distances are known in addition (e.g. observing the time of flight from reflection (from B and E) to A), then parabolic phase shifter settings may be used at the PAAs of A, to focus transmit power of the intended signal in the position of B and to send jamming signals focused at the position of E. Another countermeasure would be to initiate spatial hopping, i.e., splitting the intended signal into small chunks, each chunk being transmitted over a different direction (ideally excluding direction toward E), using a different beam. Only those beams will be used, which end at position of B, possibly via reflections (nonline of sight (NLOS) links). These beams are not necessarily the optimum beams for data transfer from A to B, but may be sufficiently good to allow secure communication. It is highly unlikely that eavesdropper E can intercept small energy portions from all such beams, since E is located in a different position than B (even though E may be located in the same direction).

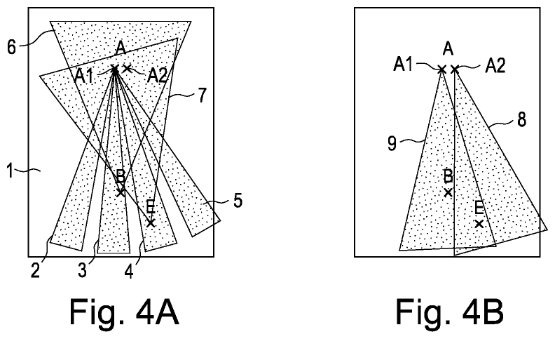

This allows the first communication device (A in FIGS. 4A and 4B illustrating an embodiment for increasing security of messaging according to the present disclosure) to detect the direction of a potential eavesdropper E by systematically sending out probe signals 1 to 5 (see FIG. 4A) into different directions and detecting potential echoes 6 (from the second communication device) and 7 (from a potential eavesdropper). Subsequently, now that the position (at least the direction of the position) of E with respect to A is known to A, A can, e.g., systematically jam E by transmitting a noise signal 8 into its direction, preferably in parallel to sending the message 9 to B into its direction. Hereby, the noise signal 8 is transmitted such that it does not jam B, and the message 9 is transmitted such that it is not received by E. In this context, however, care should be taken that B is still able to decode the message (while E is not). Generally, separate antenna circuitries (e.g. antenna arrays) are used for transmitting probe signals and receiving echo signals, which enables simultaneous transmission of probe signals and reception of echo signals (e.g. using multiple antenna beams of the antenna circuitry use for receiving echo signals). In other embodiments the same antenna circuitry is used both for transmitting probe signals and receiving echo signals.

In an embodiment, A is equipped with two different phased array antennas A1 and A2, as shown in FIGS. 4A and 4B. In this embodiment, the first PAA A1 is transmitting probe signals using beams 1 to 5 that are different in the angular domain to detect the eavesdropper E by exploiting the unavoidable radar cross-section of the eavesdropper's antenna array. Therefore, part of the energy is directly transmitted back from E to A so that E can be detected. A might also use different beams of the second PAA A2 in the angular domain and receive echoes of its transmitted signals, which (according to Equation (1)) increases the received signal power by increasing G_{RX}. Additionally, with this angular resolution the second PAA A2 can disturb E directly to thereby enhance the security for the message exchange and the communication between A and B. Generally, B and E may be detected from the received echo signals by evaluating one or more properties (like power and/or delay and/or direction and/or estimated effective cross-section) of the received echo signals.

Preferably, as shown in FIG. 4A, A is transmitting probe signals 1 to 5 into multiple spatial directions using one RF chain of a H-MIMO configuration and receives potential echoes 6 and 7 reflected by B and E. After localization of B and E, A can in one embodiment transmit the secret message 9 to B using a different beam direction (and optionally a different beam width) while specifically jamming E with a noise signal 8.

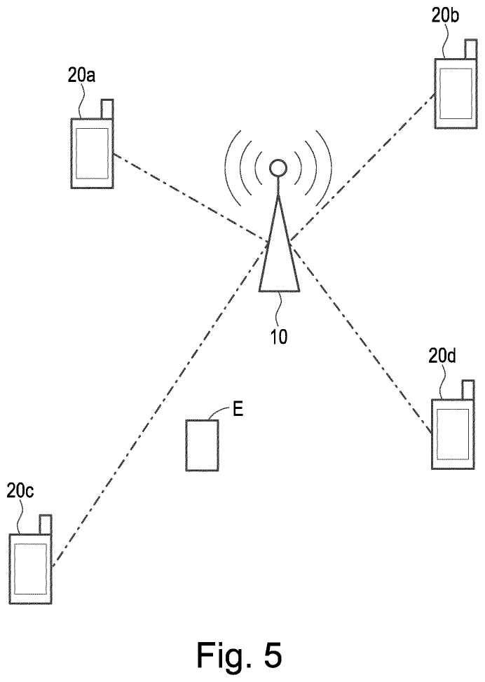

FIG. 5 shows a schematic diagram of a communication system in which the present disclosure may be applied. The communication system is configured with a first communication device 10 (e.g. representing a device A) and one or more second communication devices 20 (e.g. representing one or more devices B). Each of the first and second communication devices 10 and 20 have a wireless communication function. Particularly, the first communication device 10 has a communication function of transmitting frames to one or more second communication devices 20. Further, in an embodiment the first communication device 10 operates as an access point (AP) and the second communication devices 20 operate as a station (STA); in other embodiments both devices 10 and 20 may operated as stations. Communication from the AP 10 to the STA 20 is referred to as downlink (DL) and communication from the STA 20 to the AP 10 is referred to as uplink (UL).

For example, as illustrated in FIG. 5, the communication system may be configured with the AP 10 and one or more STAs 20a to 20d. Further, a potential eavesdropper E may be present that e.g. seeks to eavesdrop on the communication between the AP 10 and one or more of the STAs. The AP 10 and the STAs 20a to 20d are connected to each other via wireless communication and perform transmission and reception of frames directly with each other. For example, the AP 10 is a communication device conforming to IEEE 802.11 and transmits a MU DL PPDU (multi-user downlink PHY protocol data unit) having each of the STAs 20a to 20d as a destination.

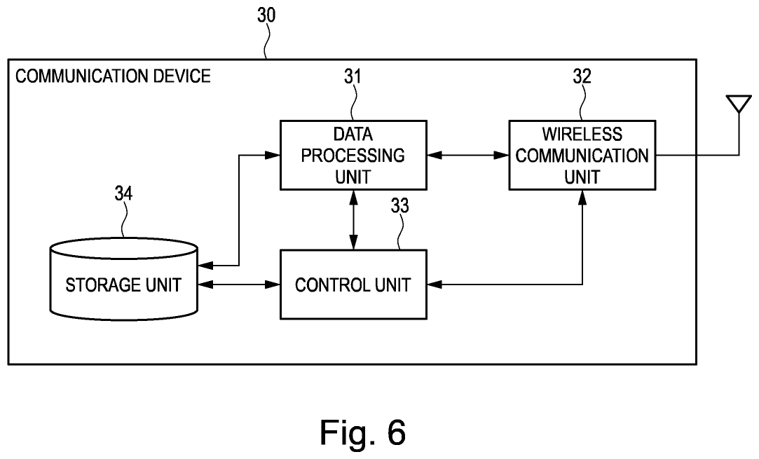

FIG. 6 shows a schematic diagram of the configuration of a communication device 30 according to an embodiment of the present disclosure. Generally, each of the AP 10 and the STAs 20a to 20d may be configured as shown in FIG. 6 and may include a data processing unit 31, a wireless communication unit 32, a control unit 33, and a storage unit 34.

As a part of a communication device 30, the data processing unit 31 performs a process on data for transmission and reception. Specifically, the data processing unit 31 generates a frame on the basis of data from a higher layer of the communication device 30, and provides the generated frame to the wireless communication unit 32. For example, the data processing unit 31 generates a frame (in particular a MAC frame) from the data by performing processes such as fragmentation, segmentation, aggregation, addition of a MAC header for media access control (MAC), addition of an error detection code, or the like. In addition, the data processing unit 31 extracts data from the received frame, and provides the extracted data to the higher layer of the communication device 30. For example, the data processing unit 31 acquires data by analyzing a MAC header, detecting and correcting a code error, and performing a reorder process, or the like with regard to the received frame.

The wireless communication unit 32 has a signal processing function, a wireless interface function, and the like as part of a communication unit. Further, a beamforming function is provided. This unit generates and sends PHY layer packets (or, in particular for a WLAN standard, PHY layer protocol data units (PPDU)).

The signal processing function is a function of performing signal processing such as modulation on frames. Specifically, the wireless communication unit 32 performs encoding, interleaving, and modulation on the frame provided from the data processing unit 31 in accordance with a coding and modulation scheme set by the control unit 33, adds a preamble and a PHY header, and generates a PHY layer packet. Further, the wireless communication unit 32 recovers a frame by performing demodulation, decoding, and the like on the PHY layer packet obtained by a process of the wireless interface function, and provides the obtained frame to the data processing unit 31 or the control unit 33.

The wireless interface function is a function to transmit/receive a signal via one or more antennas. Specifically, the wireless communication unit 32 converts a signal related to the symbol stream obtained through the process performed by the signal processing function into an analog signal, amplifies the signal, filters the signal, and up-converts the frequency. Next, the wireless communication unit 32 transmits the processed signal via the antenna. In addition, on the signal obtained via the antenna, the wireless communication unit 32 performs a process that is opposite to the process at the time of signal transmission such as down-conversion in frequency or digital signal conversion.

The beamforming function performs analog beamforming and/or digital beamforming, including beamforming training, as generally known in the art.

As a part of the communication unit, the control unit 33 (e.g., station management entity (SME)) controls entire operation of the communication device 30. Specifically, the control unit 33 performs a process such as exchange of information between functions, setting of communication parameters, or scheduling of frames (or packets) in the data processing unit 31.

The storage unit 34 stores information to be used for processing by the data processing unit 31 or the control unit 33. Specifically, the storage unit 34 stores information stored in a transmission frame, information acquired from a receiving frame, information on a communication parameter, or the like.

In an alternative embodiment, the first and second communication devices, in particular each of the AP 10 and the STAs 20, may be configured by use of circuitry that implements the units shown in FIG. 6 and the functions to be carried out. The circuitry may e.g. be realized by a programmed processor. Generally, the functionalities of first and second communication devices and the units of the communication device 30 shown in FIG. 6 may be implemented in software, hardware or a mix of software and hardware.

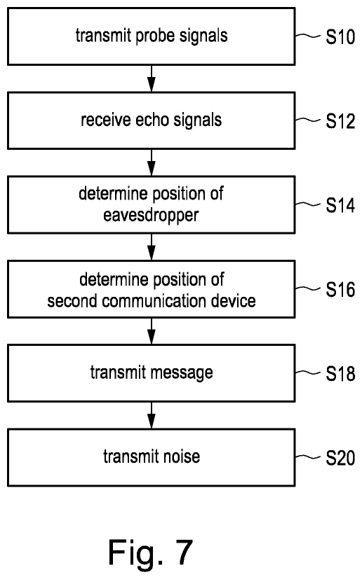

FIG. 7 illustrates an embodiment of a communication method of a first communication device for use in a wireless communication system to communicate with a second communication device according to the present disclosure. In a first step S10, the first communication device transmits probe signals into multiple directions. Echo signals are—simultaneously or thereafter—received by the first communication device in response to the transmitted probe signals (step S12). From the received echo signals, the first communication device determines in step S14 at least the position of a potentially eavesdropping communication device. Optionally, in an embodiment, the position of the second communication device is determined as well (step S16).

In an embodiment knowledge about the position of the second communication device is used in step S18 by the first communication device to transmit a message into a first direction suitable for exchanging information with the second communication device. The first direction may hereby be determined from the position of the second communication device and/or the received echo signals. In an embodiment, steps S18 and S20 may be carried out at the same time.

In another embodiment, the first communication device transmits noise into a second direction suitable for reaching the potentially eavesdropping communication device (step S20). The second direction may hereby be determined from the position of the potentially eavesdropping communication device and/or the received echo signals.

The transmission of the noise may be made simultaneously to the transmission of the message.

Another embodiment may be configured to distinguish between the potentially eavesdropping communication device and uncritical communication devices (including the second communication device, but also other communication devices that are potentially no eavesdropper) based on a metric.

Another embodiment may be configured to distinguish between the potentially eavesdropping communication device and uncritical communication devices based on a metric using one or more of the properties of the reflected signal, the properties including the amount of reflected signal energy, frequency selectivity, signal amplitudes, and signal phases.

The disclosed solution is well suited to be adopted by future products according to the standard IEEE 802.11ay or amendments thereof, because i) it leverages the mmWave and in particular Hybrid MIMO concepts that is required for those products and ii) applications might be found in internet of things (IOT) use cases that require physical layer security either because constraints like computational complexity or power consumption prohibit application of conventional cryptographic methods. Further, the disclosed techniques are advantageous when the signals rather than the payload information need to be protected (which is the case for conventional cryptography).

An example is the transmission of the position of tracking devices. When a device A transmits its position information to a base station B, it can encrypt the position information, but when sending the encrypted message, A discloses its position (from the transmitted waveform itself). Hence, a potential eavesdropper that receives the encrypted signal at multiple positions can triangulate A's position.

Thus, the foregoing discussion discloses and describes merely exemplary embodiments of the present disclosure. As will be understood by those skilled in the art, the present disclosure may be embodied in other specific forms without departing from the spirit or essential characteristics thereof. Accordingly, the disclosure of the present disclosure is intended to be illustrative, but not limiting of the scope of the disclosure, as well as other claims. The disclosure, including any readily discernible variants of the teachings herein, defines, in part, the scope of the foregoing claim terminology such that no inventive subject matter is dedicated to the public.

In the claims, the word “comprising” does not exclude other elements or steps, and the indefinite article “a” or “an” does not exclude a plurality. A single element or other unit may fulfill the functions of several items recited in the claims. The mere fact that certain measures are recited in mutually different dependent claims does not indicate that a combination of these measures cannot be used to advantage.

In so far as embodiments of the disclosure have been described as being implemented, at least in part, by software-controlled data processing apparatus, it will be appreciated that a non-transitory machine-readable medium carrying such software, such as an optical disk, a magnetic disk, semiconductor memory or the like, is also considered to represent an embodiment of the present disclosure. Further, such a software may also be distributed in other forms, such as via the Internet or other wired or wireless telecommunication systems.

The elements of the disclosed devices, apparatus and systems may be implemented by corresponding hardware and/or software elements, for instance appropriated circuits or circuitry. A circuit is a structural assemblage of electronic components including conventional circuit elements, integrated circuits including application specific integrated circuits, standard integrated circuits, application specific standard products, and field programmable gate arrays. Further, a circuit includes central processing units, graphics processing units, and microprocessors which are programmed or configured according to software code. A circuit does not include pure software, although a circuit includes the above-described hardware executing software. A circuit or circuitry may be implemented by a single device or unit or multiple devices or units, or chipset(s), or processor(s).

It follows a list of further embodiments of the disclosed subject matter:

1. A first communication device for use in a wireless communication system to communicate with a second communication device, the first communication device comprising circuitry configured to
transmit probe signals into multiple directions,
receive echo signals in response to the transmitted probe signals, and
determine the position of a potentially eavesdropping communication device from the received echo signals.
   2. The first communication device according to embodiment 1,
   wherein the circuitry is configured to transmit a message into a first direction suitable for exchanging information with the second communication device.
   3. The first communication device according to embodiment 2,
   wherein the circuitry is configured to determine the position of the second communication device from the received echo signals and to determine the first direction into which the message is then transmitted.
   4. The first communication device according to any preceding embodiment,
   wherein the circuitry is configured to transmit noise into a second direction suitable for reaching the potentially eavesdropping communication device.
   5. The first communication device according to embodiment 2 and 4,
   wherein the circuitry is configured to simultaneously or at least partly simultaneously transmit the message and the noise.
   6. The first communication device according to embodiment 2 and 4,
   wherein the circuitry comprises first antenna circuitry configured to transmit the message and second antenna circuitry configured to transmit the noise.
   7. The first communication device according to embodiment 6,
   wherein the first antenna circuitry and the second antenna circuitry each comprises a phased antenna array.
   8. The first communication device according to any one of embodiments 3 to 7,
   wherein the circuitry is configured to transmit the message using a message antenna beam that covers the position of the second communication device.
   9. The first communication device according to any one of embodiments 2 to 8,
   wherein the circuitry is configured to transmit the message using a message antenna beam that does not cover the position of the potentially eavesdropping communication device.
   10. The first communication device according to any preceding embodiment,
   wherein the circuitry is configured to transmit the noise using a noise antenna beam that does not cover the position of the second communication device and that covers the position of the potentially eavesdropping communication device.
   11. The first communication device according to any preceding embodiment,
   wherein the circuitry is configured to transmit the probe signals using multiple probe antenna beams.
   12. The first communication device according to any preceding embodiment,
   wherein the circuitry is configured to recognize the second communication device and the potentially eavesdropping communication device from the received echo signals by evaluating one or more properties of the received echo signals, the properties including power, delay, direction and estimated effective cross-section.
   13. The first communication device according to any preceding embodiment,
   wherein the circuitry comprises first antenna circuitry configured to transmit the probe signals and second antenna circuitry configured to receive the echo signals.
   14. The first communication device according to any preceding embodiment,
   wherein the circuitry is configured to distinguish between the potentially eavesdropping communication device and uncritical communication devices based on a metric.
   15. The first communication device according to embodiment 14,
   wherein the circuitry is configured to distinguish between the potentially eavesdropping communication device and uncritical communication devices based on a metric using one or more of the properties of the reflected signal, the properties including the amount of reflected signal energy, frequency selectivity, signal amplitudes, and signal phases.
   16. The first communication device according to any preceding embodiment,
   wherein the circuitry is configured to distinguish between the second communication device and the potentially eavesdropping communication device based on whether or not a communication device takes part in a beamforming process with the first communication device.
   17. The first communication device according to any preceding embodiment,
   wherein the circuitry is configured to use analog beams tested during analog beamforming training as probe signals.
   18. The first communication device according to any preceding embodiment,
   wherein the circuitry is configured to obtain the position of the second communication device and/or of the potentially eavesdropping device through one or more of beamforming training, beam refinement or fine time measurement between the first communication device and the second communication device.
   19. The first communication device according to any preceding embodiment,
   wherein the circuitry is configured to focus transmit power of the message in the position of the second communication device and to focus noise at the position of the potentially eavesdropping communication device.
   20. The first communication device according to any preceding embodiment,
   wherein the circuitry is configured to initiate spatial hopping by splitting the message into message portions and transmitting them over different directions.
   21. A first communication method of a first communication device for use in a wireless communication system to communicate with a second communication device, the first communication method comprising
transmitting probe signals into multiple directions,
receiving echo signals in response to the transmitted probe signals, and
determining the position of a potentially eavesdropping communication device from the received echo signals.
   22. A non-transitory computer-readable recording medium that stores therein a computer program product, which, when executed by a processor, causes the method according to embodiment 21 to be performed.
   23. A computer program comprising program code means for causing a computer to perform the steps of said method according to embodiment 21 when said computer program is carried out on a computer.

1. A first communication device for use in a wireless communication system to communicate with a second communication device, the first communication device comprising circuitry configured to
transmit probe signals into multiple directions,
receive echo signals in response to the transmitted probe signals, and
determine the position of a potentially eavesdropping communication device from the received echo signals.

2. The first communication device according to claim 1, wherein the circuitry is configured to transmit a message into a first direction suitable for exchanging information with the second communication device.

3. The first communication device according to claim 2, wherein the circuitry is configured to determine the position of the second communication device from the received echo signals and to determine the first direction into which the message is then transmitted.

4. The first communication device according to claim 1, wherein the circuitry is configured to transmit noise into a second direction suitable for reaching the potentially eavesdropping communication device.

5. The first communication device according to claim 2 or 4,
wherein the circuitry is configured to simultaneously or at least partly simultaneously transmit the message and the noise.

6. The first communication device according to claim 2 or 4,
wherein the circuitry comprises first antenna circuitry configured to transmit the message and second antenna circuitry configured to transmit the noise.

7. The first communication device according to claim 6, wherein the first antenna circuitry and the second antenna circuitry each comprises a phased antenna array.

8. The first communication device according to claim 3, wherein the circuitry is configured to transmit the message using a message antenna beam that covers the position of the second communication device.

9. The first communication device according to claim 2, wherein the circuitry is configured to transmit the message using a message antenna beam that does not cover the position of the potentially eavesdropping communication device.

10. The first communication device according to claim 1, wherein the circuitry is configured to transmit the noise using a noise antenna beam that does not cover the position of the second communication device and that covers the position of the potentially eavesdropping communication device.

11. The first communication device according to claim 1, wherein the circuitry is configured to transmit the probe signals using multiple probe antenna beams.

12. The first communication device according to claim 1, wherein the circuitry is configured to recognize the second communication device and the potentially eavesdropping communication device from the received echo signals by evaluating one or more properties of the received echo signals, the properties including power, delay, direction and estimated effective cross-section.

13. The first communication device according to claim 1, wherein the circuitry comprises first antenna circuitry configured to transmit the probe signals and second antenna circuitry configured to receive the echo signals.

14. The first communication device according to claim wherein the circuitry is configured to distinguish between the potentially eavesdropping communication device and uncritical communication devices based on a metric.

15. The first communication device according to claim 14, wherein the circuitry is configured to distinguish between the potentially eavesdropping communication device and uncritical communication devices based on a metric using one or more of the properties of the reflected signal, the properties including the amount of reflected signal energy, frequency selectivity, signal amplitudes, and signal phases.

16. The first communication device according to claim 1, wherein the circuitry is configured to distinguish between the second communication device and the potentially eavesdropping communication device based on whether or not a communication device takes part in a beamforming process with the first communication device.

17. The first communication device according to claim 1, wherein the circuitry is configured to use analog beams tested during analog beamforming training as probe signals.

18. The first communication device according to claim 1, wherein the circuitry is configured to obtain the position of the second communication device and/or of the potentially eavesdropping device through one or more of beamforming training, beam refinement or fine time measurement between the first communication device and the second communication device.

19. A first communication method of a first communication device for use in a wireless communication system to communicate with a second communication device, the first communication method comprising
transmitting probe signals into multiple directions,
receiving echo signals in response to the transmitted probe signals, and
determining the position of a potentially eavesdropping communication device from the received echo signals.

20. A non-transitory computer-readable recording medium that stores therein a computer program product, which, when executed by a processor, causes the method according to claim 19 to be performed.
